(19) United States
(12) Patent Application Publication
(10) Pub. No.: US 2003/0046075 A1
(43) Pub. Date: Mar. 6, 2003

(54) Apparatus and methods for providing television speech in a selected language

(75) Inventor: Christopher J. Stone, Newtown, PA (US)

Correspondence Address: LAW OFFICE OF BARRY R LIPSITZ, 755 MAIN STREET, MONROE, CT, 06468, US

(73) Assignee: General Instrument Corporation, Horsham, PA

(21) Appl. No.: 09/943,142

(22) Filed: Aug. 30, 2001

(51) Int. Cl. G10L 15/18

(52) U.S. Cl. 704/257

(57) ABSTRACT

Television speech is provided in a desired language using closed caption data already present in a received television signal. The closed caption data, which is representative of words, is extracted from the television signal. The closed caption data is then processed in a speech synthesizer to provide said words as speech in a desired language. The closed caption data can be translated from a first language to a second language prior to or concurrently with conversion to speech. Alternatively, the closed caption data can be carried in various languages in the television signal, and the data in the desired language can be selected for extraction from the television signal and conversion to speech.

### BACKGROUND OF THE INVENTION

The present invention relates to television systems, and more particularly to apparatus and methods for allowing a television program to be provided in a language other than that recorded with the program.

Television programs include both a video portion and an audio portion. The audio portion is recorded in a language that is typical for the locale in which the program is broadcast. However, not all residents of a particular locale speak the same language. Accordingly, it would be advantageous to provide for the selection of a particular language in which a viewer will be able to best enjoy a particular television program.

Prior art solutions to the language problem have generally focussed on the provision of one or more additional audio signals, each carrying the audio portion of the television program in a different language. For example, various proposals for digital television transmission include a provision for a second audio program (SAP) which can be used to provide, e.g., television audio in a second language. A problem with such a solution is that each separate audio signal requires additional bandwidth in the broadcast signal. The use of such additional bandwidth is undesirable, as it consumes space that could otherwise be used for revenue generating services, such as additional programming.

In the past, closed caption data has been provided to enable the hearing impaired to view the audio portion of a television program as text. Such data is carried in analog and digital television signals in accordance with applicable television standards, such as the National Television Systems Committee (NTSC) standard for analog television in the United States, and the Moving Picture Experts Group (MPEG) standards for digital television. In the past, closed caption data has only been used for such display of text.

It would be advantageous to provide a system for enabling a viewer to choose any one of a number of different languages for the audio portion of a television program. It would be further advantageous for such a system to provide different languages without requiring additional bandwidth for each language.

The present invention provides a television audio system having the above and other advantages.

### SUMMARY OF THE INVENTION

The present invention enables a television viewer to select the language in which television speech will be provided. In order to provide this ability, closed caption data is extracted from the television signal. The closed caption data is representative of words. The extracted closed caption data is processed in a speech synthesizer to provide the words as speech in the desired language.

A user interface is provided to enable the user to select one of a plurality of languages capable of being provided by the speech synthesizer. The user interface can include, e.g., a television on-screen display. In such an embodiment, the user interacts with the on-screen display via a television remote control.

Since the television signal will typically already include an audio portion in a first language, this audio portion will be muted if another language is selected. In this manner, the audio portion carried with the television program will not interfere with the audio output of the speech synthesizer.

In one embodiment, the closed caption data is first converted to text. The text is then converted to speech. The closed caption data can be representative of words in the desired language. Alternatively, the closed caption data can be representative of words in a language that is different from the desired language, in which case processing will be provided to translate the words into the desired language prior to synthesizing speech therefrom.

Apparatus for implementing a preferred embodiment of the invention includes a closed caption processor adapted to extract closed caption data from a television signal having an audio portion in a first language, the closed caption data being representative of words. A speech synthesizer is provided to convert the words represented by the closed caption data to speech in a second language.

The user interface, which enables user selection of the second language, can comprise, for example, a remote control that allows the user to interact with a television on-screen display. A mute circuit is provided for muting an audio portion of the television signal when replacement speech is provided from the speech synthesizer.

The invention can also be implemented, at least in part, in a software program adapted to provide television speech in a selected language. Such software can include a closed caption processor module adapted to extract closed caption data from a television signal having an audio portion in a first language, said closed caption data being representative of words. The software can further include a speech synthesis module adapted to convert the words represented by said closed caption data to speech in a second language.

The software program can further comprise a user interface module for enabling a user to select one of a plurality of different languages as the second language. The user interface module can, for example, include software code for generating an on-screen display to enable the user to select the desired second language using a remote control. A mute module can also be provided for actuating a mute circuit to mute an audio portion of the television signal when replacement speech is provided from the speech synthesis module.

The closed caption module of the software program can be designed to convert the closed caption data to text for processing into speech by the speech synthesis module. The text can be provided in the second language. Alternatively, the text can be in a language other than the selected second language, in which case the speech synthesis module can be adapted to translate the text to the second language for processing into speech. The software program can be provided on a machine readable media.

A method is also disclosed for providing audio from a television signal in a selected one of a plurality of different languages, where the television signal includes the audio in one of the languages. A user selects one of the languages. If the selected language is not the language included in the television signal, the language included in the television signal is converted to the selected language for audio presentation to the user. In one implementation, the language is converted from text provided in a closed caption signal. In another implementation, the language is converted from the audio portion of the television signal.

### BRIEF DESCRIPTION OF THE DRAWINGS

FIG. 1 is a block diagram showing the main components of a system in accordance with the present invention; and

FIG. 2 is a block diagram showing an example software implementation of the invention.

### DETAILED DESCRIPTION OF THE INVENTION

The present invention uses closed caption data representative of words, in conjunction with a speech synthesizer, to provide television audio output in a desired language. In this manner, the television viewing experience is enhanced by allowing a viewer to select a language other than the main language associated with the program, as the language that the user will hear when listening to the program. In the past, when a viewer wanted to listen to a program in a language other than the language associated therewith, the content provider would have to supply a second language with the program. This requirement limited the number of languages available, and placed the burden on the content provider to supply additional languages. The present invention overcomes this problem by utilizing the closed caption data and a text-to-speech converter (i.e., a “speech synthesizer”) to convert the closed caption text to a user selected language. The selected language is then presented to the user instead of the main language carried by the program.

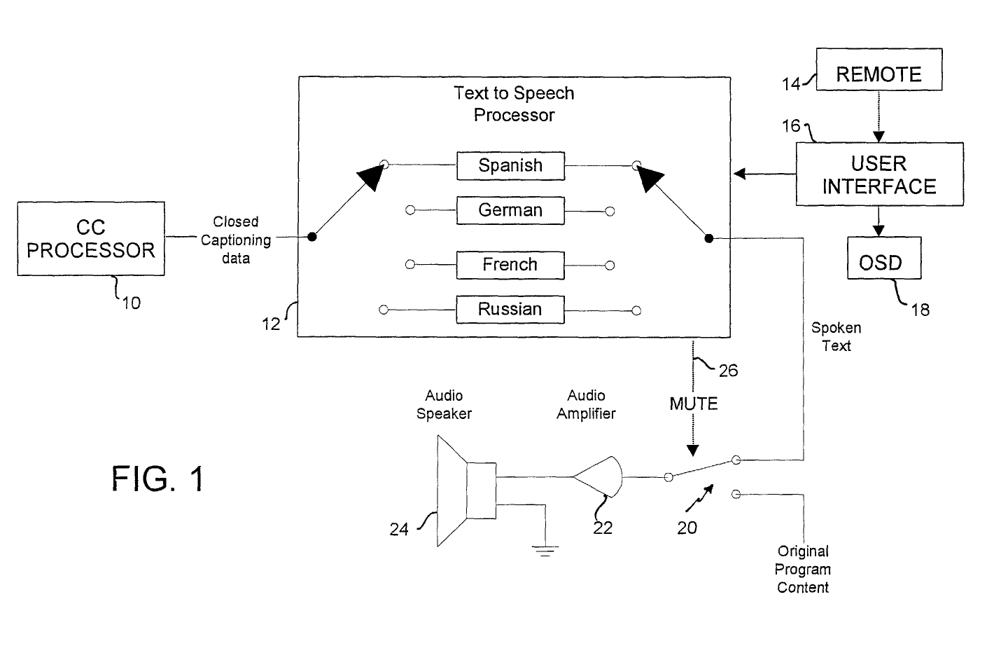

FIG. 1 illustrates the relevant hardware components of the invention. A closed caption processor 10 extracts closed captioning data (e.g., in the form of text) from a received television program. The closed captioning data is provided to a text-to-speech processor 12, which includes text recognition and/or translation software for converting the closed captioning data to a selected language. Although FIG. 1 illustrates the capability of the processor 12 to convert the closed caption text from, e.g., English to Spanish, German, French or Russian, it should be appreciated that any starting language can be accommodated and any ending language can be provided by providing appropriate software.

Text-to-speech processors are well known in the art, and any suitable such device can be used in order to implement the present invention. For example, Oki Electric Industry Co., Ltd. of Tokyo, Japan markets its model MSM7630 multi-lingual speech control processor (SCP) with text-to-speech synthesis capability in six languages including American English, European English, French, German, Spanish, and Japanese. This product uses a single large scale integrated circuit chip with a 12-bit D/A (digital-to-analog) converter to provide a natural sounding voice using time domain-pitch synchronous overlap-add technology to replicate waveforms in human voices. Both parallel and serial interfaces are provided to accommodate various implementations. A user dictionary can be programmed to expand vocabulary, and is available in Flash-ROM (read only memory) for easy upgrades.

The text-to-speech processor 12 of the present invention is programmed to provide as output any desired one of a number of selectable languages. The languages can be changed and/or expanded, for example, by providing additional software modules that are either downloaded to the device, or installed by inserting a non-volatile memory card (e.g., Flash-ROM) or the like into a receptacle in the device. A user can be provided with an electromechanical switch, or with a graphical user interface (GUI) or the like in order to make the language selection. In a preferred embodiment, a GUI is provided on the user's television screen using, e.g., standard on-screen-display (OSD) hardware and software 18, which displays a list of available languages that the device is capable of “speaking.” The user can then select a language using the television remote control 14, for example, by pressing a button (such as a number button) thereon that corresponds to the desired language. The remote control response is detected by a user interface 16 (e.g., via infrared (IR) signal reception), which actuates the text-to-speech processor to convert the received closed caption text to the requested language.

When a language other than the main language in which the program is received is selected, the text-to-speech processor 12 provides a switching signal to a switch 20, in order to couple the output of the text-to-speech processor to the television audio amplifier 22 and speaker 24. When the switch 20 is coupled to the text-to-speech processor, the original program audio is muted, as it is disconnected from the audio circuitry 22, 24. When it is desired to hear the original program language, the switch 20 is switched to couple the original television audio output to the amplifier 22 and speaker 24.

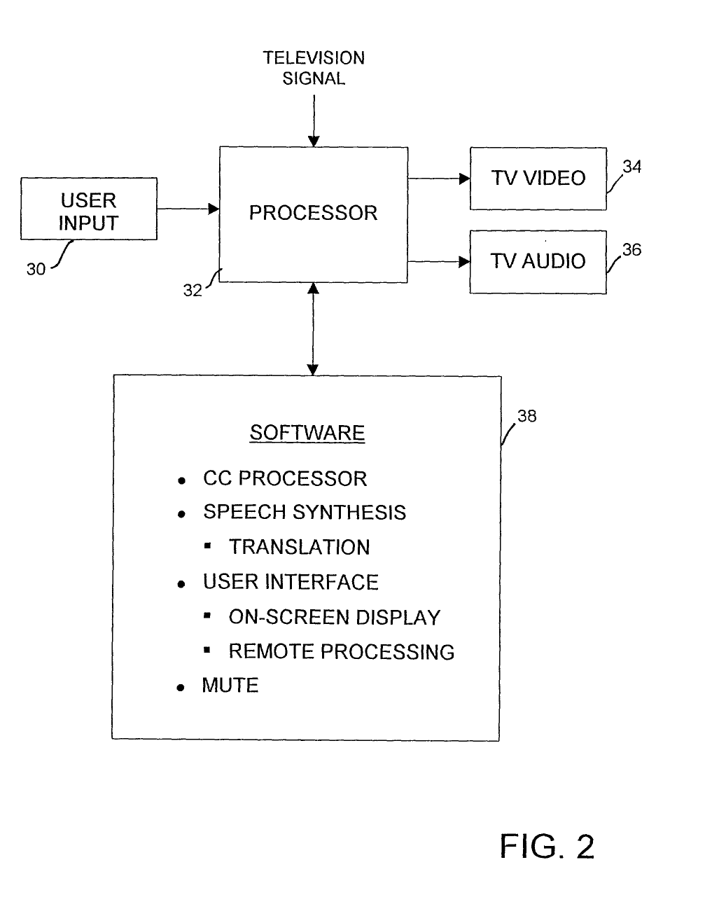

FIG. 2 provides a flowchart of processing and software components that can be used to implement the invention. In particular, user input 30 (i.e., language selection) is provided to a processor 32, which can be the microprocessor already provided in a television settop. An example of a microprocessor controlled settop box is the DCT-5000 manufactured by the Broadband Communications Sector of Motorola, Inc., Horsham, Pa. USA. The processor also receives a digital television signal, which contains a main language audio portion as well as closed caption data. It is noted that although FIG. 2 illustrates the processing of a digital television signal, closed caption data is also carried in analog television signals, and can be extracted for input to processor 32 in digital form.

The processor 32 provides television video 34 and audio 36 to a user's television in a conventional manner. In accordance with the present invention, software 38 is included for use in providing the television audio 36 in a selected alternate language. The software 38 can reside in a non-volatile memory portion of the settop, such as in ROM, and can be installed at the factory or warehouse, or downloaded into the settop via the cable television network, via telephone lines, or via a wireless communication path, for example. Alternatively, the software can be stored in a hard drive or other memory portion of a personal versatile recorder (PVR) device, personal computer (PC) attached to the settop, or the like.

As indicated in FIG. 2, the software 38 includes a module for implementing the closed caption processor which extracts the closed caption (CC) data from the television signal. The closed caption processor module provides the closed caption data in text form to a speech synthesis module, which translates the text to the desired language, and provides the translated text as speech to the audio circuits of the user's television or other video appliance, such as a video tape recorder, PVR, or the like.

Software 38 also includes a user interface module, which provides an on-screen display for enabling users to select the language which they want to hear. The interface module also handles the decoding of user input signals from the television (or settop, VCR, PVR, etc.) remote control. A mute module is also provided to mute the main program audio output so that the selected alternate language can be heard via the television audio system. It should be appreciated that the implementation shown in FIG. 2 is for purposes of illustration only, and that other implementations can be provided in accordance with the invention.

It should now be appreciated that the present invention provides a new use for closed caption data. Instead of using such data to present text to the hearing impaired, it is used to provide audio speech in different languages to viewers who can hear the speech. As an alternative, the closed caption text can be carried in the television signal in different languages, which can be directly input into a text-to-speech processor for conversion to speech without any need for translation.

Although the invention has been described in connection with a specific embodiment thereof, it should be appreciated that various modifications and adaptations can be made thereto without departing from the scope of the invention, as set forth in the claims.

What is claimed is:

1. A method for providing television speech in a selected language comprising:
extracting closed caption data from a television signal, said closed caption data being representative of words; and
processing the extracted closed caption data in a speech synthesizer to provide said words as speech in a desired language.

2. A method in accordance with claim 1, comprising providing a user interface to enable a user to select one of a plurality of languages capable of being provided by said speech synthesizer.

3. A method in accordance with claim 2, wherein said user interface includes a television on-screen display.

4. A method in accordance with claim 3, wherein said user interacts with said on-screen display via a television remote control.

5. A method in accordance with claim 1, wherein said television signal includes an audio portion and a video portion, comprising the further step of muting said audio portion.

6. A method in accordance with claim 1, wherein said processing step converts said closed caption data to text, and then converts said text-to-speech.

7. A method in accordance with claim 1, wherein said closed caption data is representative of words in said desired language.

8. A method in accordance with claim 1, wherein said closed caption data is representative of words in a language that is different from the desired language, and said processing step translates said words into said desired language.

9. Apparatus for providing television speech in a selected language comprising:
a closed caption processor adapted to extract closed caption data from a television signal having an audio portion in a first language, said closed caption data being representative of words; and
a speech synthesizer adapted to convert the words represented by said closed caption data to speech in a second language.

10. Apparatus in accordance with claim 9, further comprising:
a user interface operatively associated with said speech synthesizer for enabling a user to select one of a plurality of different languages as said second language.

11. Apparatus in accordance with claim 10, wherein said user interface includes a television on-screen display.

12. Apparatus in accordance with claim 11, wherein said user interface further comprises a remote control for enabling said user to interact with said on-screen display.

13. Apparatus in accordance with claim 9, further comprising a mute circuit for muting an audio portion of said television signal when replacement speech is provided from said speech synthesizer.

14. Apparatus in accordance with claim 9, wherein said closed caption processor converts said closed caption data to text for processing into speech by said speech synthesizer.

15. Apparatus in accordance with claim 14, wherein said text is in said second language.

16. Apparatus in accordance with claim 14, wherein said text is in a language other than said second language, and said speech synthesizer is adapted to translate said text to said second language for processing into speech.

17. A software program for providing television speech in a selected language comprising:
a closed caption processor module adapted to extract closed caption data from a television signal having an audio portion in a first language, said closed caption data being representative of words; and
a speech synthesis module adapted to convert the words represented by said closed caption data to speech in a second language.

18. A software program in accordance with claim 17, further comprising a user interface module for enabling a user to select one of a plurality of different languages as said second language.

19. A software program in accordance with claim 18, wherein said user interface module includes software code for generating an on-screen display to enable said user to select said second language using a remote control.

20. A software program in accordance with claim 17, further comprising a mute module for actuating a mute circuit to mute an audio portion of said television signal when replacement speech is provided from said speech synthesis module.

21. A software program in accordance with claim 17, wherein said closed caption module converts said closed caption data to text for processing into speech by said speech synthesis module.

22. A software program in accordance with claim 21, wherein said text is in said second language.

23. A software program in accordance with claim 21, wherein said text is in a language other than said second language, and said speech synthesis module is adapted to translate said text to said second language for processing into speech.

24. A machine-readable media containing the software program of claim 17.

25. A method for providing audio from a television signal in a selected one of a plurality of different languages, said television signal including said audio in one of said languages, comprising:
allowing a user to select one of said languages; and
if the selected language is not the language included in said television signal, converting the language included in said television signal to the selected language for audio presentation to said user.

26. A method in accordance with claim 25, wherein the language is converted from text provided in a closed caption signal.

27. A method in accordance with claim 25, wherein the language is converted from the audio portion of said television signal.
